(19) United States
(12) Patent Application Publication
(10) Pub. No.: US 2016/0153645 A1
(43) Pub. Date: Jun. 2, 2016

(54) ELECTROLUMINESCENT LIGHTING SYSTEM

(71) Applicant: Tamara Ann Leuty, New York, NY (US)

(72) Inventor: Tamara Ann Leuty, New York, NY (US)

(21) Appl. No.: 15/014,866

(22) Filed: Feb. 3, 2016

Related U.S. Application Data
(63) Continuation-in-part of application No. 14/843,378, filed on Sep. 2, 2015.
Application No. 14/843,378 is a continuation-in-part of application No. 13/666,022, filed on Nov. 1, 2012, now Pat. No. 9,144,282.
(60) Provisional application No. 62/111,328, filed on Feb. 3, 2015.
(60) Provisional application No. 61/554,078, filed on Nov. 1, 2011.
(60) Provisional application No. 61/554,262, filed on Nov. 1, 2011.
(60) Provisional application No. 61/554,078, filed on Nov. 1, 2011.
(60) Provisional application No. 61/554,262, filed on Nov. 1, 2011.
(60) Provisional application No. 62/111,328, filed on Feb. 3, 2015.

(51) Int. Cl. F21V 23/04; F21V 23/02; F21V 33/00

(52) U.S. Cl. CPC F21V 23/04; F21V 23/0464; F21V 23/0471; F21V 33/0004; F21V 23/02; F21Y 2105/006

(57) ABSTRACT

The present invention includes an improved electroluminescent light source(s) for at least one items and methods of making the same. More specifically, the invention includes an improved laminated electroluminescent light source(s) for at least one items.

### CROSS-REFERENCE TO RELATED APPLICATIONS

This application is a continuation-in-part of U.S. Nonprovisional Application No. 14/843,378, filed Sep. 2, 2015. U.S. Nonprovisional Application No. 14/843,378 is a continuation-in-part of and claims priority from U.S. Nonprovisional Application No. 13/666,022, filed Nov. 1, 2012. U.S. Nonprovisional Application No. 13/666,022 claims priority from U.S. Provisional Application No. 61/554,078, filed Nov. 1, 2011, and U.S. Provisional Application No. 61/554,262, filed Nov. 1, 2011. Additionally, this application claims priority from U.S. Provisional Application No. 62/111,328, filed Feb. 3, 2015. PCT application PCT/US15/48803 also claims benefit to U.S. Nonprovisional Application No. 14/843,378.

### BACKGROUND OF THE INVENTION

The present invention relates to an improved electroluminescent light source(s) to be inserted into items and methods of making the same. More specifically, the invention relates to laminated electroluminescent light source(s) for items.

The present invention addresses these problems.

### SUMMARY OF THE INVENTION

The present invention provides an improved electroluminescent lighting system. The improved electroluminescent light source comprising of an improved electroluminescent light system comprising: at least one electroluminescent light source; further comprising at least one of a permanent and/or removable battery or other power storage device and wherein the battery or other power storage device further comprises at least one of: at least one connector to connect the at least one battery or other power storage device to the at least one electroluminescent light source or at least one connector to connect the at least one battery or other power storage device to the at least one electroluminescent light source and at least one connector to connect the at least one battery or other power storage device to an outside source of power to recharge, or that said permanent and/or removable battery or other power storage device is inserted into a battery pack or driver which comprises at least one of at least one connector to connect the at least one battery pack to the at least one electroluminescent light source or at least one connector to connect the at least one battery pack and at least one connector to connect the at least one battery pack to an outside source of power to recharge; at least one of: at least one light switch or at least one light switch coupled to the light, magnetic switch, for turning the at least one electroluminescent light source on and/or off; a laminate covering for the at least one electroluminescent light source [Which among other things is laminated for protection from heat, pressure, ultra violet (UV) light]; the light given off by the at least one electroluminescent light source is in a hue conducive to enabling vision in the presence of low ambient light; wherein the laminate covering extends beyond the perimeter of the at least one electroluminescent light source to form an edge of laminating material. wherein the at least one electroluminescent light source comprises a thin or flat flexible, elastic material; wherein the said light panel, showing durability of this light panel, and including the said wiring, are washable, water resistant, and heat resistant (can be placed in a washer and/or dryer) so that a simple removal of the said battery pack or unit is all that is required to wash the whole lighting panel; wherein said battery pack if present is additional comprised of two connection jacks (ports). A battery pack or driver has ports (can be labeled “A” and “B”), One port receives wire to connect the light source to the battery driver to power the light source. and the other port connects via wire to a switch. The invention wherein the at least one electroluminescent light source may be permeable or impermeable, may have at least one of the following: wherein the at least one electroluminescent light source is presently affixed to, on, or in a product or wherein the at least one electroluminescent light source is presently affixed to, on, or in a product and the battery compartment is either not located in, or on, the at least one item or the battery compartment is separated and placed on or in a second at least one item but connected via wire or other connection devise and/or may have that at least one of the at least one light switches is an automatic light switch which automatically turns on at least one of the at least one electroluminescent light sources in response to a product containing the invention being opened and/or in response to detecting a predetermined level of ambient light; wherein at least one of the at least one light switches may be at least one manual light switch or wherein at least one of the at least one light switches is at least one magnetic light switch; wherein the at least one item may have at least one opening and at least one of the at least one manual light switches if present is located at or near at least one of the openings in the at least one item. wherein at least one electroluminescent light source may be located on, or near, the top of the at least one item, or on more than one side portion, or most, or all of the entire perimeter of the inside of the at least one item, so to produce light which covers the entire perimeter of the inside and/or top of the at least one item wherein the at least one electroluminescent light source may be designed to be located and is located on at least one of the one or more side portions proximate the top portion of a at least one item the at least one item having an interior liner for abutting the interior surface and the edge of laminating material of at least one electroluminescent light source being attached [any device for attaching, glue, sewing thread, Velcro, snaps, zippers] to the interior liner of the said at least one item; wherein the at least one electroluminescent light may be located between the interior surface and the interior liner of at least one item; wherein at least one item may have an interior liner said the interior liner has an opening for displaying at least a portion of the at least one electroluminescent light source; the battery back can be inserted into a pocket of the said at least one item that holds the battery pack which is affixed to the inside or outside of a at least one item; wherein the pocket may have an opening for the connector and/or an object connected to the battery to exit the pocket.

### BRIEF DESCRIPTION OF THE SEVERAL VIEWS OF THE DRAWING

FIG. 1 is a top front perspective drawing illustrating an embodiment of the invention in three parts, light panel, wires A and B and top back front and side view of battery.

FIG. 2 is a top view drawing illustrating the electroluminescent light panel as being thin and flexible.

FIG. 3 illustrates one embodiment of the invention showing A plug going to light panel, B plug going to switch, shows three sides of battery pack, screw to take apart or hold panel in place.

FIG. 4 is a drawing of the battery pack illustrating an embodiment of a battery pack with A and B for locations the wires go to.

FIG. 5 is a top view perspective drawing illustrating another embodiment of the invention with all the components connected.

FIG. 6 is a side view drawing illustrating of the invention in a handbag.

FIG. 7 is a top side view of the battery pack with batteries.

FIG. 8 is a side view illustrating another embodiment of the invention in a bag with lighting panel on above the middle backside lining of said bag, shows wire going through grommet of battery pocket within lining, shows other wire from battery pocket going to magnet switch through lining showing on/off switch closed.

FIG. 9 is anther side front-view drawing illustrating the invention in a handbag with the on/off switch open.

FIG. 10 is a front view of another embodiment of the invention in a bag showing electroluminescent lighting located in the flap of a handbag in around the perimeter of a mirror.

FIG. 11 is top view drawing of the invention showing the manual on/off switch on top of the battery inside a clutch handbag.

FIG. 12 is a front view of the invention showing the small battery conductor built into a clutch bag with a plug hole for the charger. Side view on the outside also illustrates the on/off manual switch.

FIG. 13 is side-view drawing illustrating an embodiment of the charger plug for recharging the battery built with in the clutch bag.

FIG. 14 is a top open view illustrating the invention in a briefcase.

FIG. 15 is a front view of another embodiment of the invention in a handbag with lighting system under interior zipper and close to top of bag on lining attached to back wall.

FIG. 16 is a front view illustrating another embodiment of the invention in a tent with lighting panel on above the middle backside lining of said tent, shows wire going to battery pocket.

FIG. 17 is a top view of another embodiment of the invention built into a carpet runner on each side lighting the pathway with a power plug connected.

FIG. 18 shows embodiments of the invention in luggage and depict various views with horizontal lighting system. Other embodiments could be vertical lighting system placemen

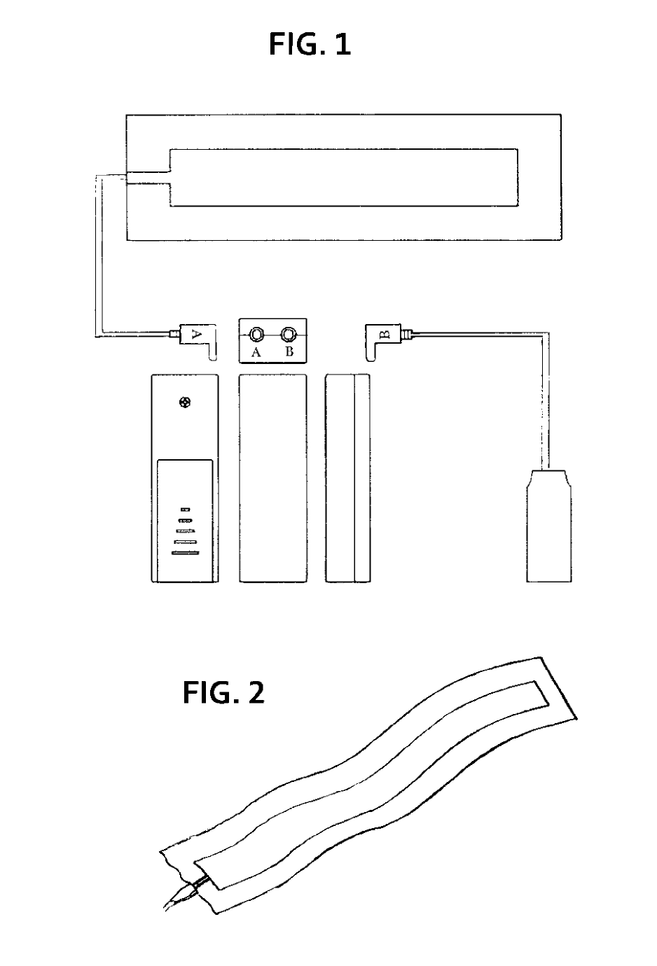

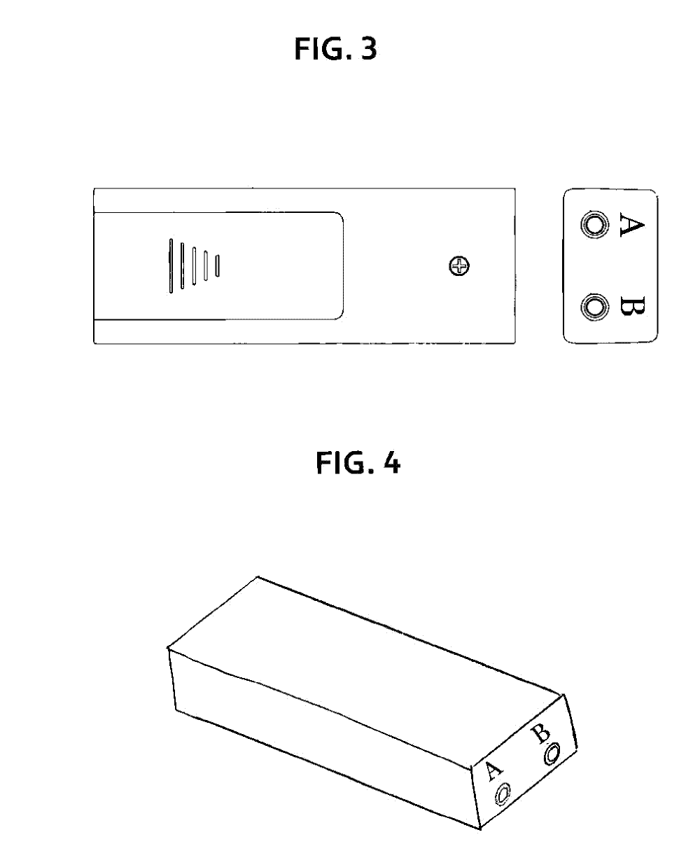

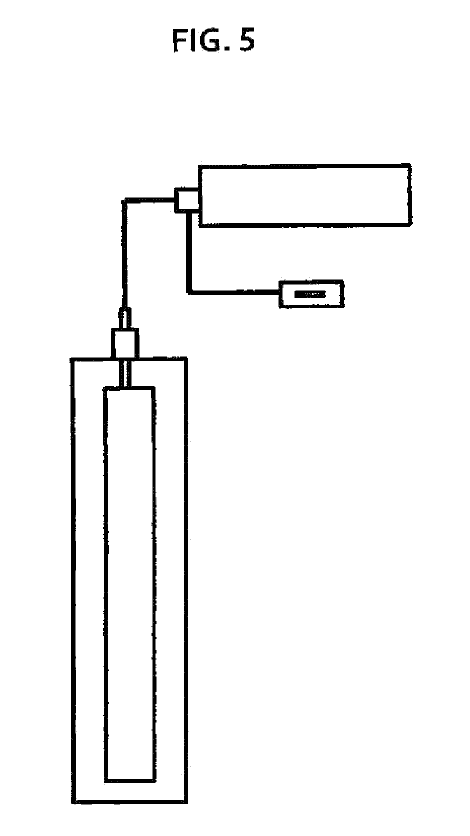

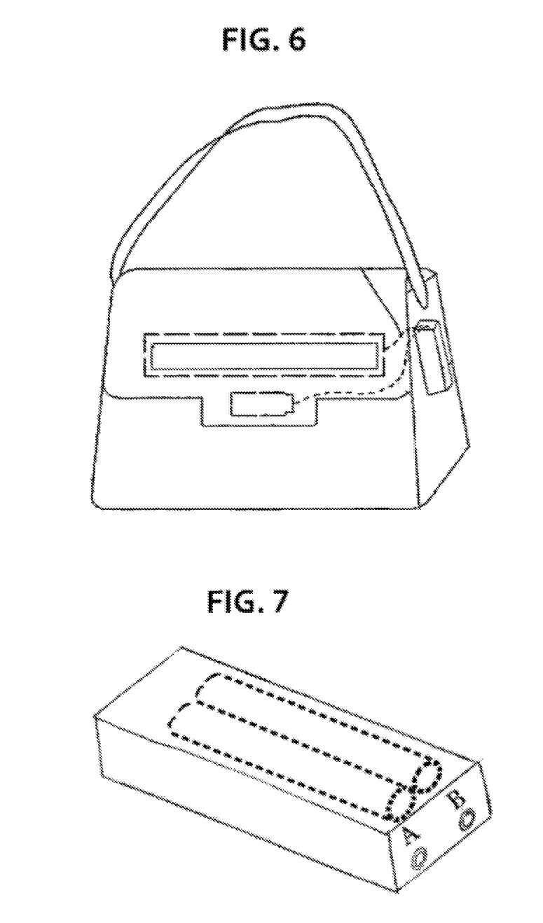

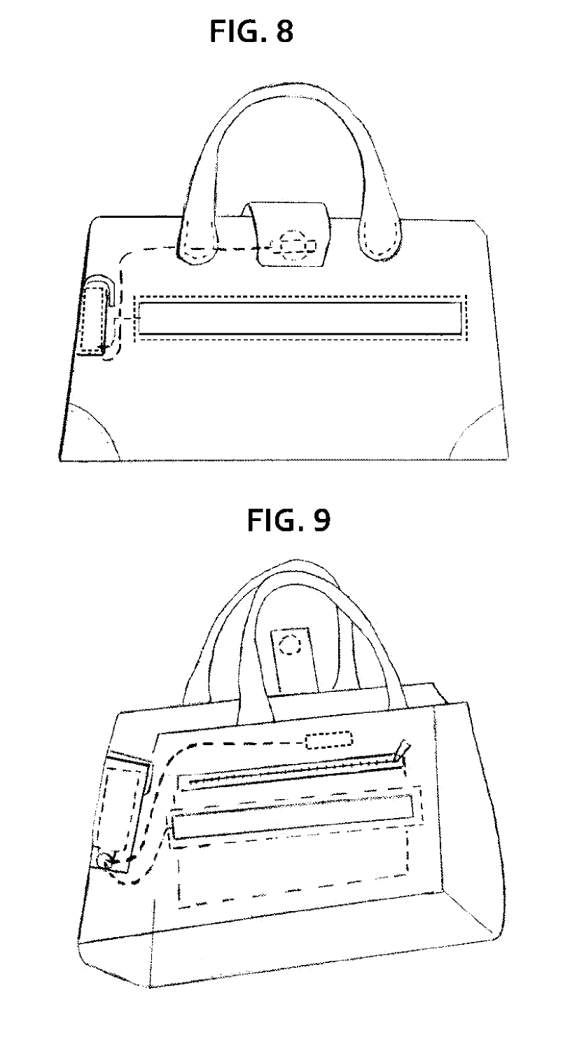

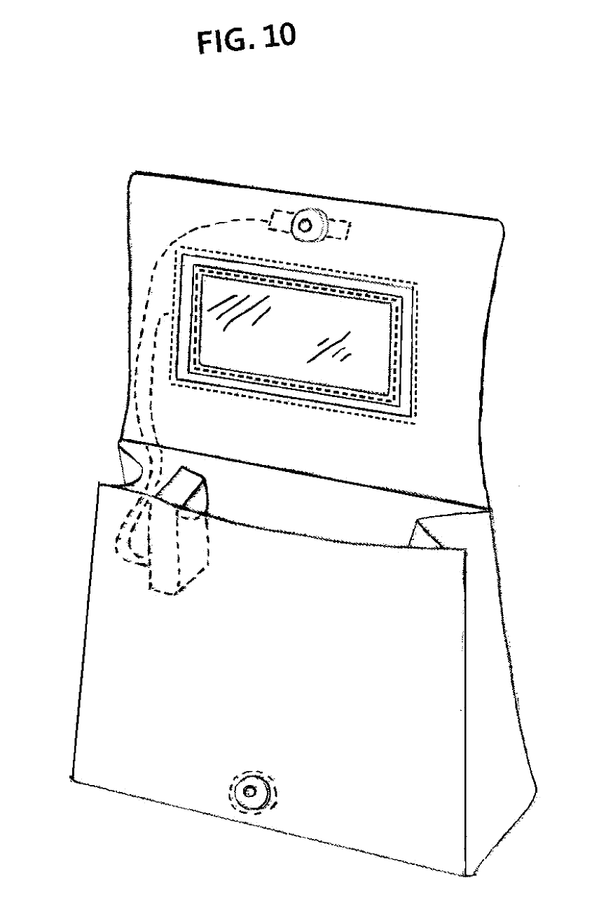

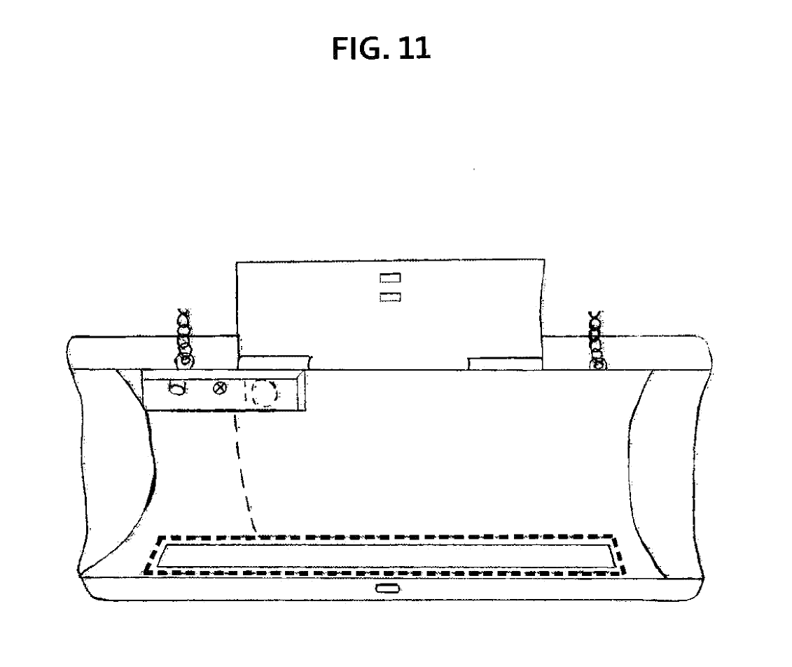

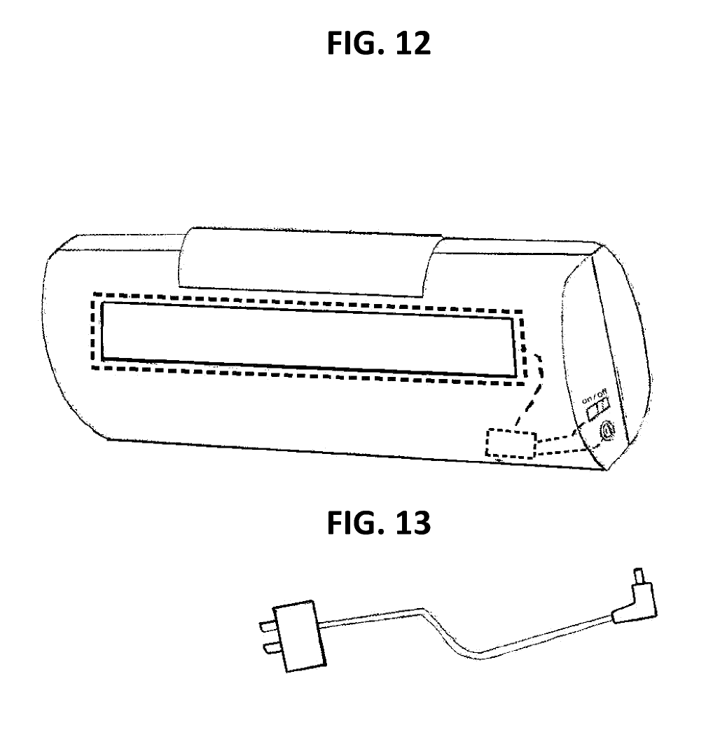

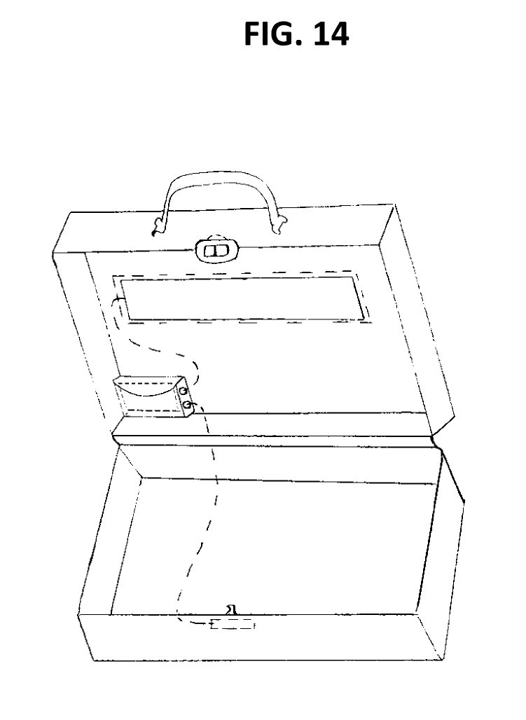

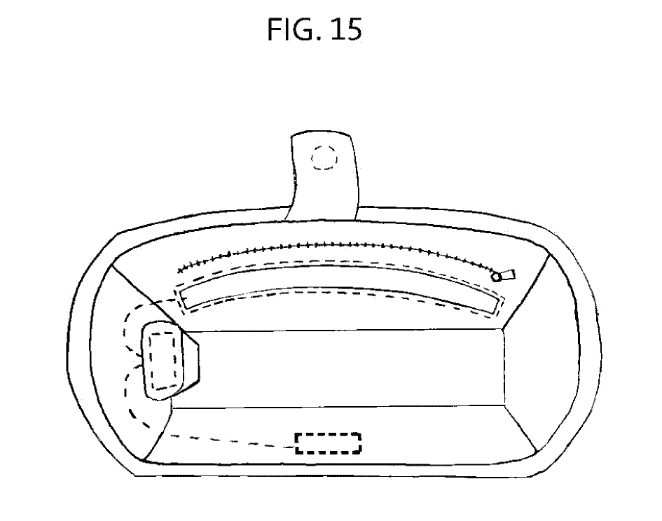

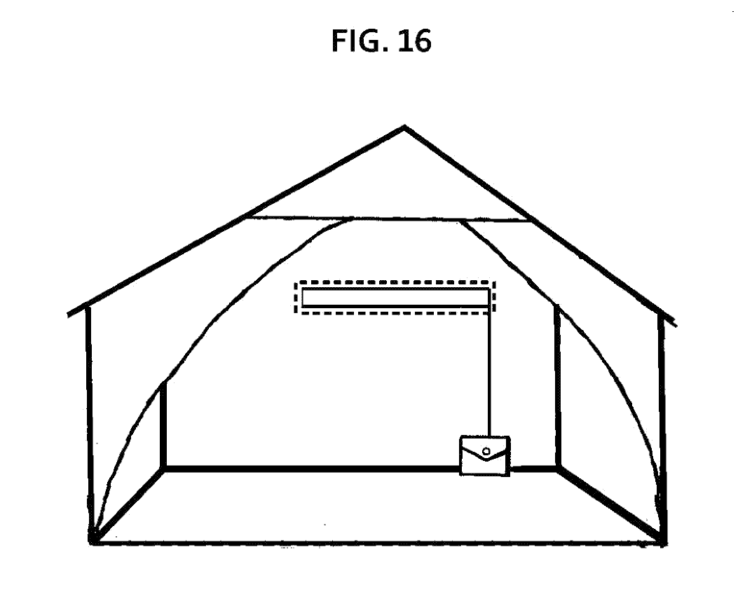

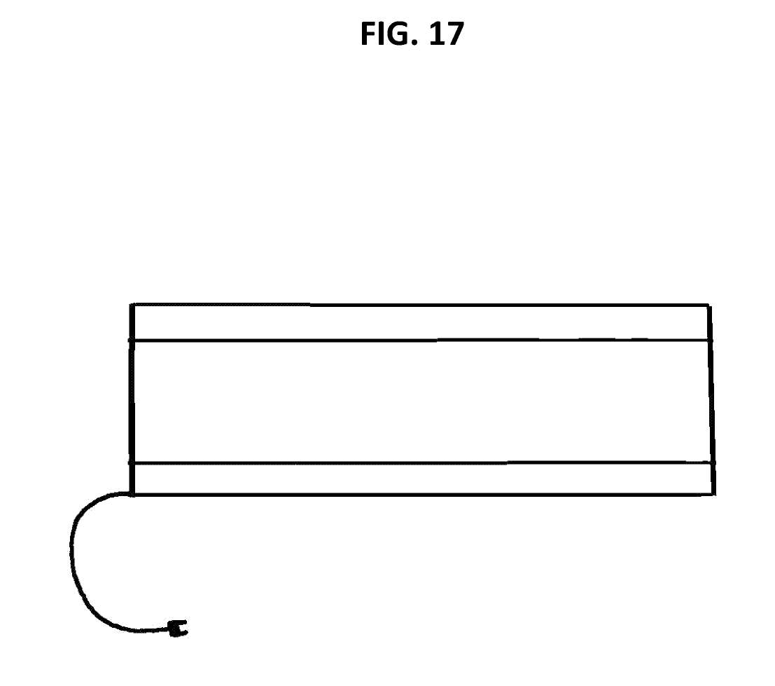

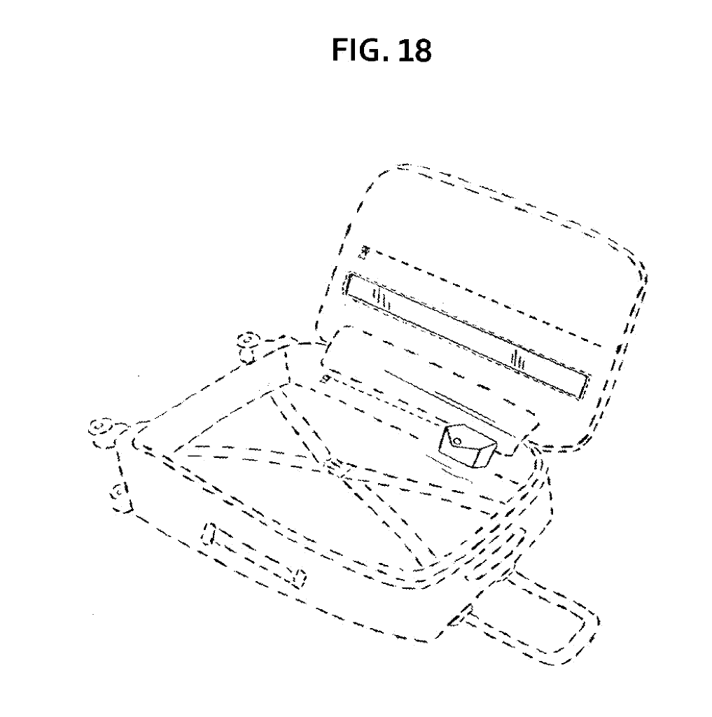

The drawings are not necessarily to scale. Like numbers used in the figures refer to like components, steps, and the like. However, it will be understood that the use of a number to refer to a component in a given figure is not intended to limit the component in another figure labeled with the same number.

Similarly, except as explicitly required by claim language, a single substance or component may meet more than a single functional requirement, provided that the single substance fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention.

Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to herein including but not limited to any original claims.

### DEFINITIONS

Unless otherwise indicated, the words and phrases presented in this document have their ordinary meanings to one of skill in the art.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the explanations given in this specification.

As used herein, the term “and/or” refers to any one of the items, any combination of the items, or all of the items with which this term is associated.

At least one item: Can be any consumer product for sale, or any physical object, or any structure, or any wall, floor, or ceiling.

As used herein the phrase “battery pack” refers to a battery or a set of any number of (preferably) identical batteries or individual battery cells and additionally may comprise at least one of a housing, battery door, screw, wiring, wiring and/or plug(s), jacks, circuitry, plug device.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the terms “include,” “for example,” “such as,” and the like are used illustratively and are not intended to limit the present invention.

As used herein, the phrase “mechanically coupled” refers to bringing two or more items together or into relationship with each other in any number of ways including a direct or indirect physical connection that may be releasable (snaps, rivets, screws, bolts, welds, etc.), movable (rotating, pivoting, oscillating, etc.), or a combination thereof.

As used herein, the phrase “operatively coupled” refers to bringing two or more items together or into relationship with each other such that they may operate together or allow transfer of information between the two or more items.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As defined within, the term “purse” refers to a receptacle, such as a handbag, pocketbook, or wallet that is used by a person to carry money and other small objects. As such, a purse can include, for example, a clutch, a tote, a briefcase, a handbag, a shoulder bag, or a makeup bag.

As used herein, the terms “front,” “back,” “rear,” “upper,” “lower,” “side”, “right,” and “left” in this description are merely used to identify the various elements as they are oriented in the FIGS, with “front,” “back,” and “rear” being relative apparatus. These terms are not meant to limit the element which they describe as the various elements may be oriented differently in various applications.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

As used herein, the term “bag” means any type of container handbag, purse, tote bag, briefcase, backpack. A bag can be described as a container of flexible and/or inflexible material, such as paper, plastic, or leather, that is used for carrying or storing items.

In one embodiment, the “bag” includes, can be, or is a clutch, a tote, a briefcase, a wallet, a handbag, a shoulder bag, a duffel bag, a garment bag, a suitcase and/or a makeup bag, or luggage. In at least one embodiment, the “bag” includes a clutch. In at least one embodiment, the bag includes a tote. In at least one embodiment, the bag includes or is a briefcase. In at least one embodiment, the “bag” includes or is a handbag. In at least one embodiment, the “bag” includes or is a shoulder “bag”. In at least one embodiment, the “bag” includes or is a makeup bag. In at least one embodiment, the “bag” includes or is a wallet. In at least one embodiment, the “bag” includes or is a duffel bag. In at least one embodiment, the “bag” includes or is a suitcase. In at least one embodiment, the “bag” includes or is a garment bag. The “bag” is not limited to any design, material, or shape found in any of the drawings of any of the embodiments described herein. In at least one embodiment, the “bag” includes or is luggage.

As used herein, the term “panel” generally refers to a flat or curved component, typically rectangular, that forms or is set into the surface of a door, wall, or ceiling and/or is any shape, rectangular, square, triangular, circular.

As used herein, the term “strip” refers to a component that is more narrow and smaller than a panel.

As used herein, the terms “electroluminescent” and “electroluminescent light(s)” means a panel or strip or wire or other form, and can be an LED, LED light source, LED light panel, electroluminescent light source, edge-lit panel and/or a combination thereof.

As used herein, the term “hue” means a gradation or variety of a color.

As used herein, the term “ambient light” means the light surrounding an environment or subject, and can also be called available light or existing light.

What is claimed:

1. An improved electroluminescent light system comprising:
at least one electroluminescent light source;
further comprising at least one of a permanent and/or removable battery or other power storage device and wherein the battery or other power storage device further comprises at least one of: at least one connector to connect the at least one battery or other power storage device to the at least one electroluminescent light source or at least one connector to connect the at least one battery or other power storage device to the at least one electroluminescent light source and at least one connector to connect the at least one battery or other power storage device to an outside source of power to recharge, or that said permanent and/or removable battery or other power storage device is inserted into a battery pack or driver which comprises at least one of at least one connector to connect the at least one battery pack to the at least one electroluminescent light source or at least one connector to connect the at least one battery pack and at least one connector to connect the at least one battery pack to an outside source of power to recharge;
at least one light switch [coupled to the light, magnetic switch] for turning the at least one electroluminescent light source on and/or off;
a laminate covering for the at least one electroluminescent light source [laminated for protection from heat, pressure, ultra violet (UV) light];
the light given off by the at least one electroluminescent light source is in a hue conducive to enabling vision in the presence of low ambient light;
wherein the laminate covering extends beyond the perimeter of the at least one electroluminescent light source to form an edge of laminating material;
wherein the at least one electroluminescent light source comprises a thin or flat flexible, elastic material;
wherein the said light panel, showing durability of this light panel, and including the said wiring, are washable, water resistant, and heat resistant (can be placed in a washer and/or dryer) so that a simple removal of the said battery pack or unit is all that is required to wash the whole lighting panel;
wherein said battery pack if present is additional comprised of two connection jacks (ports). A battery pack or driver has ports (can be labeled “A” and “B”), One port receives wire to connect the light source to the battery driver to power the light source. and the other port connects via wire to a switch.

2. The invention of claim 1, wherein the at least one electroluminescent light source is permeable or impermeable.

3. The invention of claim 1, having at least one of the following: wherein the at least one electroluminescent light source is presently affixed to, on, or in a product or wherein the at least one electroluminescent light source is presently affixed to, on, or in a product and the battery compartment is either not located in, or on, the at least one item or the battery compartment is separated and placed on or in a second at least one item but connected via wire or other connection devise.

4. The invention of claim 1, wherein at least one of the at least one light switches is an automatic light switch which automatically turns on at least one of the at least one electroluminescent light sources in response to a product containing the invention being opened and/or in response to detecting a predetermined level of ambient light.

5. The invention of claim 1, wherein at least one of the at least one light switches is at least one manual light switch or wherein at least one of the at least one light switches is at least one magnetic light switch.

6. The invention of claim 1, wherein the at least one item has at least one opening and at least one of the at least one manual light switches if present is located at or near at least one of the openings in the at least one item.

7. The invention of claim 1, wherein at least one electroluminescent light source is located on, or near, the top of the at least one item, or on more than one side portion, or most, or all of the entire perimeter of the inside of the at least one item, so to produce light which covers the entire perimeter of the inside and/or top of the at least one item.

8. The invention of claim 1, wherein the at least one electroluminescent light source is designed to be located and is located on at least one of the one or more side portions proximate the top portion of a at least one item the at least one item having an interior liner for abutting the interior surface and the edge of laminating material of at least one electroluminescent light source being attached [any device for attaching, glue, sewing thread, Velcro, snaps, zippers] to the interior liner of the said at least one item.

9. The invention of claim 1, wherein the at least one electroluminescent light is located between the interior surface and the interior liner of at least one item.

10. The invention of claim 1, wherein at least one item having an interior liner said the interior liner has an opening for displaying at least a portion of the at least one electroluminescent light source.

11. The invention of claim 1, the battery back can be inserted into a pocket of the said at least one item that holds the battery pack which is affixed to the inside or outside of a at least one item.

12. The invention of claim 1, wherein the pocket has an opening for the connector and/or an object connected to the battery to exit the pocket.
